(19) United States
(12) Patent Application Publication
(10) Pub. No.: US 2008/0159575 A1
(43) Pub. Date: Jul. 3, 2008

(54) ELECTRONIC DEVICE WITH INTERNAL UNI-DIRECTIONAL MICROPHONE

(75) Inventors: Ying-Te Chu, Sanchong City (TW); Gwo-Liang Yang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/616,914

(22) Filed: Dec. 28, 2006

(51) Int. Cl. H04R 1/02

(52) U.S. Cl. 381/346; 381/353

(57) ABSTRACT

An electronic device includes a case, a sound absorbing tunnel, and a uni-directional microphone. The case defines a front acoustic opening and a rear acoustic opening. The sound absorbing tunnel is disposed in the case. The uni-directional microphone is disposed in the case, including a front to receive external sound via the front acoustic opening, and a rear to receive the external sound via the rear acoustic opening and the sound absorbing tunnel.

### BACKGROUND OF THE INVENTION

1. Field of the Invention

The invention relates to an electronic device including an internal uni-directional microphone.

2. Description of the Related Art

A uni-directional microphone is capable of clearly receiving sound from a particular direction (typically from the front side of the microphone) and avoiding environmental noise, and thus is often applied in high-quality audio recorders or communications devices.

Most electronic devices (cellular phones, personal digital assistants, etc.) have plastic or metal housings which are acoustic isolators. Acoustic isolators block sound waves increasing the difficulty of microphone placement. Specifically, a uni-directional microphone presenting good performance in open space deteriorates when disposed in a housing of an electronic device, because reception of external sound is hindered by the housing. It is therefore commonly understood that a conventional uni-directional microphone must be always externally connected to an electronic device to achieve adequate quality.

### BRIEF SUMMARY OF THE INVENTION

The invention provides an electronic device including an internal uni-directional microphone which presents good performance.

The electronic device comprises a case, a sound absorbing tunnel, and a uni-directional microphone. A front acoustic opening and a rear acoustic opening are defined in the case. The sound absorbing tunnel is disposed in the case. The uni-directional microphone is disposed in the case, comprising a front for receiving external sound via the front acoustic opening, and a rear to receive the external sound via the rear acoustic opening and the sound absorbing tunnel.

The electronic device may further comprise a sound absorbing element disposed in the sound-absorbing tunnel.

The sound absorbing element may comprise sponge, foam, perforated gypsum, glass wool, stone wool, fiber, or perforated aluminum.

The electronic device may further comprise a circuit board on which the uni-directional microphone is mounted. The circuit board defines a plurality of through holes around the uni-directional microphone.

The sound absorbing tunnel comprises rubber, sponge, foam, perforated gypsum, glass wool, stone wool, fiber, or perforated aluminum.

The electronic device may further comprise a circuit board which defines a through hole, wherein the sound absorbing tunnel comprises a first tubular section and a second tubular section communicating the first tubular section through the through hole.

The electronic device may further comprise an omni-directional microphone disposed in the case and acoustically isolated from the uni-directional microphone.

The electronic device may further comprise a first chamber with the omni-directional microphone disposed therein and a second chamber with the uni-directional microphone disposed therein, wherein the first and second chambers are acoustically isolated from each other.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a front view of an electronic device in accordance with an exemplary embodiment of the invention;

FIG. 2 depicts a cross section of the electronic device of FIG. 1; and

FIG. 3 is a schematic view showing a plurality of through holes around a uni-directional microphone on a circuit board of FIG. 2.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

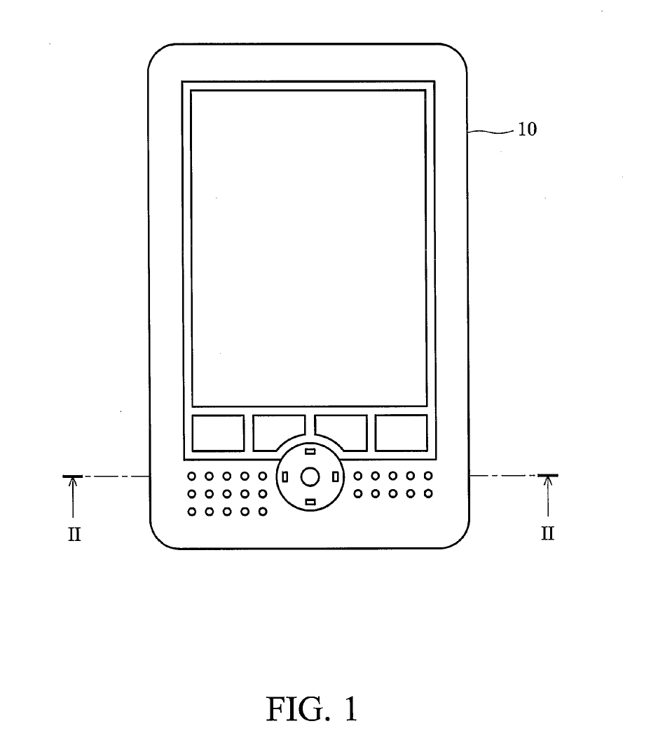

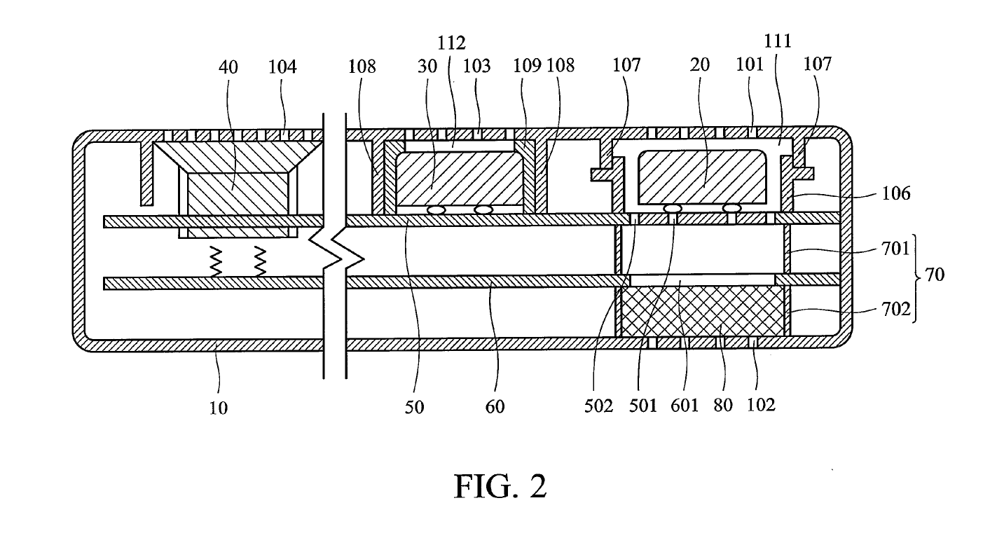

Referring to FIGS. 1 and 2, an electronic device includes a case 10, a uni-directional microphone 20, an omni-directional microphone 30, a loudspeaker 40, two circuit boards 50 and 60, a sound absorbing tunnel 70, and a sound absorbing element 80, described in the following:

The case 10 has partition walls 107 and 108 protruding inward, a plurality of front acoustic openings 101 and rear acoustic openings 102 corresponding to the uni-directional microphone 20, a plurality of front acoustic openings 103 corresponding to the omni-directional microphone 30, and a plurality of front acoustic openings 104 corresponding to the loudspeaker 40.

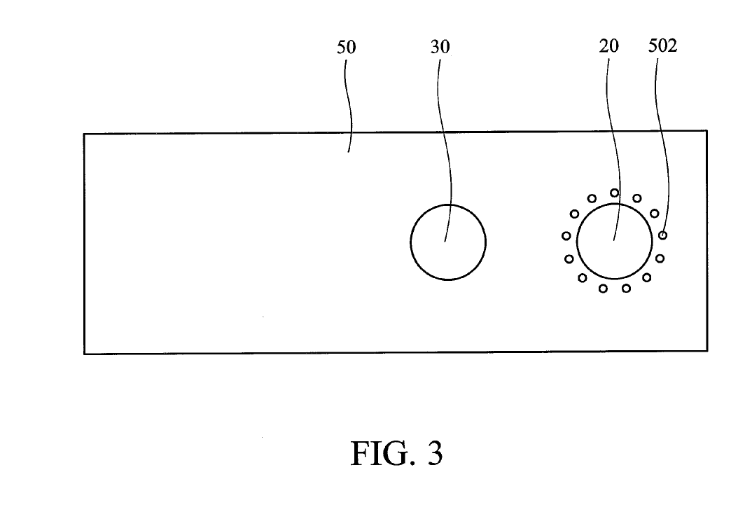

The uni-directional microphone 20 and the omni-directional microphone 30 are mounted on the circuit board 50. The circuit board 50 transmits the signals of the uni-directional microphone 20 and the omni-directional microphone 30 to another circuit board (the main circuit board) 60. Furthermore, the circuit board 50 has through holes 501 under the uni-directional microphone 20, and through holes 502 around the uni-directional microphone 20 as shown in FIG. 3.

The circuit board 60 is the main circuit board for managing signals transmitted between most elements of the electronic device, and has a through hole 601 under the uni-directional microphone 20. The loudspeaker 40 is mounted on the circuit board 70.

The uni-directional microphone 20 is disposed in a chamber 111 which is formed by the partition wall 107 and a rubber ring 106. The omni-directional microphone 30 is fitted into a rubber boot 109 and then disposed in another chamber 112 which is formed by the partition wall 108. The two chambers 111 and 112 are acoustically insulated from each other via the partition walls 107 and 108, and the rubber ring 106.

The sound absorbing tunnel 70 comprises a first tubular section 701 and a second tubular section 702. The first tubular section 701 is disposed between the circuit boards 50 and 60. The second tubular section 702 is disposed between the circuit board 60 and the case 10, and connects the first tubular section 701 through the through hole 601 of the circuit board 60. The sound absorbing tunnel 70 is made of, for example, rubber, sponge, foam, perforated gypsum, glass wool, stone wool, fiber, perforated aluminum, or other sound absorbing materials. In an exemplary embodiment, the sound absorbing tunnel 70 is made of rubber, the hardness of which is 60±10 SHA.

The sound absorbing element 80 is disposed in the second tubular section 702 and made of, for example, low-density sponge, foam, perforated gypsum, glass wool, stone wool, fiber, perforated aluminum, or other sound absorbing materials. In an exemplary embodiment, the sound absorbing element 80 is made of NBR foam, the density of which ranges between 70-90 kg/m³.

The uni-directional microphone 20 and the omni-directional microphone 30 constitute a microphone array to receive external sound. In operation, the loudspeaker 40 outputs sound via the front acoustic openings 104 of the case 10. The omni-directional microphone 30 receives external sound via the front acoustic openings 103 of the case 10. The uni-directional microphone 20 receives external sound via the front acoustic openings 101 and the rear acoustic openings 102 of the case 10. In detail, external sound waves reach the uni-directional microphone in four paths:

(1) First sound waves enter into the chamber 111 via the front acoustic openings 101 and reach the front of the uni-directional microphone 20.

(2) Second sound waves enter into the sound absorbing tunnel 70 via the rear acoustic openings 102, pass through the through holes 501 of the circuit board 50, and then reach the rear of the uni-directional microphone 20.

(3) Third sound waves enter into the chamber 111 via the front acoustic openings 101, enter into the sound absorbing tunnel 70 via the through holes 502, return to the chamber 111 via the through holes 501, and reach the rear of the uni-directional microphone 20.

(4) Fourth sound waves enter into the sound absorbing tunnel 70 via the rear acoustic openings 102, pass through the through holes 502 of the circuit board 50, and reach the front of the uni-directional microphone 20.

Both the tunnel 70 and the element 80 are made of sound absorbing material to prevent reflection of sound waves as they propagate therethrough. If the sound waves experience multiple reflections before reaching the uni-directional microphone, then either the beam-forming executed by the uni-directional microphone 20 may fail or the polar pattern obtained for the uni-directional microphone 20 is poor.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a case defining a front acoustic opening and a rear acoustic opening;
a sound absorbing tunnel disposed in the case; and
a uni-directional microphone disposed in the case, comprising a front to receive external sound via the front acoustic opening, and a rear to receive the external sound via the rear acoustic opening and the sound absorbing tunnel.

2. The electronic device as claimed in claim 1, further comprising a sound absorbing element disposed in the sound-absorbing tunnel.

3. The electronic device as claimed in claim 2, wherein the sound absorbing element comprises sponge, foam, perforated gypsum, glass wool, stone wool, fiber, or perforated aluminum.

4. The electronic device as claimed in claim 1, further comprising a circuit board on which the uni-directional microphone is mounted.

5. The electronic device as claimed in claim 4, wherein the circuit board defines a plurality of through holes around the uni-directional microphone.

6. The electronic device as claimed in claim 1, wherein the sound absorbing tunnel comprises rubber, sponge, foam, perforated gypsum, glass wool, stone wool, fiber, or perforated aluminum.

7. The electronic device as claimed in claim 1, further comprising a circuit board which defines a through hole, wherein the sound absorbing tunnel comprises a first tubular section and a second tubular section connecting the first tubular section through the through hole.

8. The electronic device as claimed in claim 1, further comprising an omni-directional microphone disposed in the case and acoustically isolated from the uni-directional microphone.

9. The electronic device as claimed in claim 8, further comprising a first chamber with the omni-directional microphone disposed therein and a second chamber with the uni-directional microphone disposed therein, wherein the first and second chambers are acoustically isolated from each other.
